(19) United States
(12) Patent Application Publication
(10) Pub. No.: US 2020/0031195 A1
(43) Pub. Date: Jan. 30, 2020

(54) PERSONALIZED ADAPTIVE HVAC SYSTEM CONTROL METHODS AND DEVICES

(71) Applicant: SAIC INNOVATION CENTER LLC, SAN JOSE, CA (US)

(72) Inventors: MATTHEW WOODS, SAN JOSE, CA (US); DALI WANG, FREMONT, CA (US); FAN JIANG, SAN JOSE, CA (US); RYAN SCOTT MIDDLETON, MOUNTAIN VIEW, CA (US)

(21) Appl. No.: 16/043,262

(22) Filed: Jul. 24, 2018

(51) Int. Cl. B60H 1/00

(52) U.S. Cl. CPC B60H 1/00742; B60H 2001/00992; B60H 1/00971; B60H 1/00878

(57) ABSTRACT

Systems and methods are provided for controlling a HVAC system of a vehicle. An exemplary method may comprise: collecting data describing environmental measurements and one or more states of the HVAC system; predicting one or more target values by inputting the collected data into one or more inference models that include a personal inference model, wherein the personal inference model is used to predict a personal target value for the vehicle or a user of the vehicle; and outputting the one or more target values including the personal target value for the vehicle or the user of the vehicle to control the HVAC system of the vehicle.

### TECHNICAL FIELD

This disclosure generally relates to personalized adaptive vehicle Heating Ventilation and Air Conditioning (HVAC) system control methods and devices.

### BACKGROUND

HVAC system control is important for providing a desired in-cabin environment for occupants of vehicles. Existing HVAC control systems either require an occupant of the vehicle to manually turn on and off or adjust the HVAC system, or merely provide a simple setting function which the occupant can use to set a few target values, such as temperatures at different times. However, manual control may take time to reach the levels desired by the occupant. In addition, manual control may distract a driver from driving safely. While some HVAC auto control units may mitigate some of the difficulties of the manual control systems, they fail to capture subtleness of occupants' preferences or variability of their behaviors, and thus cannot remove all the distraction. A personalized adaptive HVAC control is needed to provide a comfortable in-cabin environment in accordance with an occupant's specific preferences.

### SUMMARY

Various embodiments of the present disclosure can include systems, methods, and non-transitory computer readable media for controlling HVAC systems of vehicles. According to one aspect, a personalized HVAC control method may comprise: collecting data describing environmental measurements and one or more states of the HVAC system; predicting one or more target values by inputting the collected data into one or more inference models that include a personal inference model, wherein the personal inference model is used to predict a personal target value for the vehicle or a user of the vehicle; and outputting the one or more target values including the personal target value for the vehicle or the user of the vehicle to control the HVAC system of the vehicle.

In some embodiments, one or more inference models comprise a general inference model used to obtain a general target value for an average vehicle or an average user of vehicles. Predicting one or more target values may further comprise: predicting the general target value for the average vehicle or the average user of vehicles by inputting the collected data into the general inference model. The personal target value is a personal target adjustment indicating a difference of preference between the vehicle and the average vehicle or a difference of preference between the user of the vehicle and the average user of vehicles. In some embodiments, the method may further comprise combining the general target value and the personal target adjustment to obtain the one or more target values to control the HVAC system of the vehicle.

In some embodiments, the HVAC system may comprise a HVAC auto unit for controlling the HVAC system. The one or more inference models may comprise a HVAC auto unit inference model used to predict a general target value of the HVAC auto unit. The personal target value may be a personal target adjustment that indicates a difference between the general target value of the HVAC auto unit and a preferred target value of the user of the vehicle upon the HVAC auto unit. In some embodiments, the method may further comprise combining the general target value of the HVAC auto unit and the personal target adjustment to obtain the one or more target values to control the HVAC system of the vehicle.

In some embodiments, the method may further comprise: collecting historical data describing environmental measurements and one or more states of the HVAC system associated with the vehicle or the user of the vehicle; and generating the personal inference model for the vehicle or the user of the vehicle based on the historical data.

In some embodiments, the one or more inference models may be trained by using the data describing environmental measurements and one or more states of the HVAC system collected at a current time, lagged target values inferred at one or more previous times, and a current target value at the current time as training data. In some embodiments, the current target value at the current time may be set by the user or controlled by a HVAC controller of the HVAC system. In some embodiments, collecting data describing environmental measurements and one or more states of the HVAC system may comprise collecting additional data comprising one or more of vehicle state data describing one or more states of the vehicle, user identity data describing an identity of the user, user status data describing status of the user, user demographic data describing demographic information associated with the user, and external data describing external information.

According to another aspect, a personalized HVAC control system may comprise a processor and a non-transitory computer-readable storage medium storing instructions that, when executed by the processor, cause the system to perform a method for controlling a HVAC system of a vehicle. The method may comprise: collecting data describing environmental measurements and one or more states of the HVAC system; predicting one or more target values by inputting the collected data into one or more inference models that include a personal inference model, wherein the personal inference model is used to predict a personal target value for the vehicle or a user of the vehicle; and outputting the one or more target values including the personal target value for the vehicle or the user of the vehicle to control the HVAC system of the vehicle.

According to yet another aspect, a vehicle system may comprise one or more sensors equipped in or outside of a vehicle; a HVAC system equipped in the vehicle; and a computing device. The computing device may comprise: a processor and a non-transitory computer-readable storage medium. The non-transitory computer-readable storage medium may comprise instructions that, when executed by the processor, cause the processor to perform a method for controlling the HVAC system. The method may comprise: collecting data from the one or more sensors equipped in or outside of the vehicle; predicting one or more target values by inputting the collected data into one or more inference models that include a personal inference model, wherein the personal inference model is used to predict a personal target value for the vehicle or a user of the vehicle; and outputting the one or more target values including the personal target value for the vehicle or the user of the vehicle to control the HVAC system.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1A illustrates an exemplary environment for personalized HVAC control, in accordance with various embodiments.

FIG. 1B illustrates an exemplary data storage or database, in accordance with various embodiments.

FIG. 2A illustrates a diagram of Gradient Boosted Trees, in accordance with various embodiments.

FIG. 2B illustrates a diagram of model training in a mixed autoregressive context, in accordance with various embodiments.

FIG. 2C illustrates a diagram of inference based on a trained model, in accordance with various embodiments.

FIG. 3A illustrates an exemplary work flow of the personalized HVAC control, in accordance with various embodiments.

FIG. 3B illustrates another exemplary work flow of the personalized HVAC control, in accordance with various embodiments.

FIG. 3C illustrates yet another exemplary work flow of the personalized HVAC control, in accordance with various embodiments.

FIG. 4 illustrates a flowchart of an exemplary personalized HVAC control method, in accordance with various embodiments.

FIG. 5A illustrates a flowchart of another exemplary personalized HVAC control method, in accordance with various embodiments.

FIG. 5B illustrates a flowchart of yet another exemplary personalized HVAC control method, in accordance with various embodiments.

FIG. 6A illustrates a flowchart of an exemplary method for generating a personal inference model for a vehicle or user, in accordance with various embodiments.

FIG. 6B illustrates a flowchart of an exemplary method for generating a general inference model for a normal vehicle or user, in accordance with various embodiments.

FIG. 7 illustrates a block diagram of an exemplary computer system in which any of the embodiments described herein may be implemented.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

The present disclosure is related to personalized adaptive HVAC control methods and devices for controlling the in-cabin environment of vehicles. The present methods and devices provide control over in-cabin airflow, recirculation, and temperature in response to environmental conditions both inside and outside of the vehicles, and thus provide an in-vehicle environment that is comfortable for the vehicle occupants. The present methods and devices also enable a personalized adaptive HVAC control that adapts to the preferences of the occupant or occupants of a vehicle. For example, the methods and devices can initiate environmental control to increase comfort level of vehicle occupants in accordance with their specific preferences. Further, the methods and devices can continually adjust in response to environmental measurements from sensors so as to match occupants' preferences based on the history of occupant-initiated environmental controls.

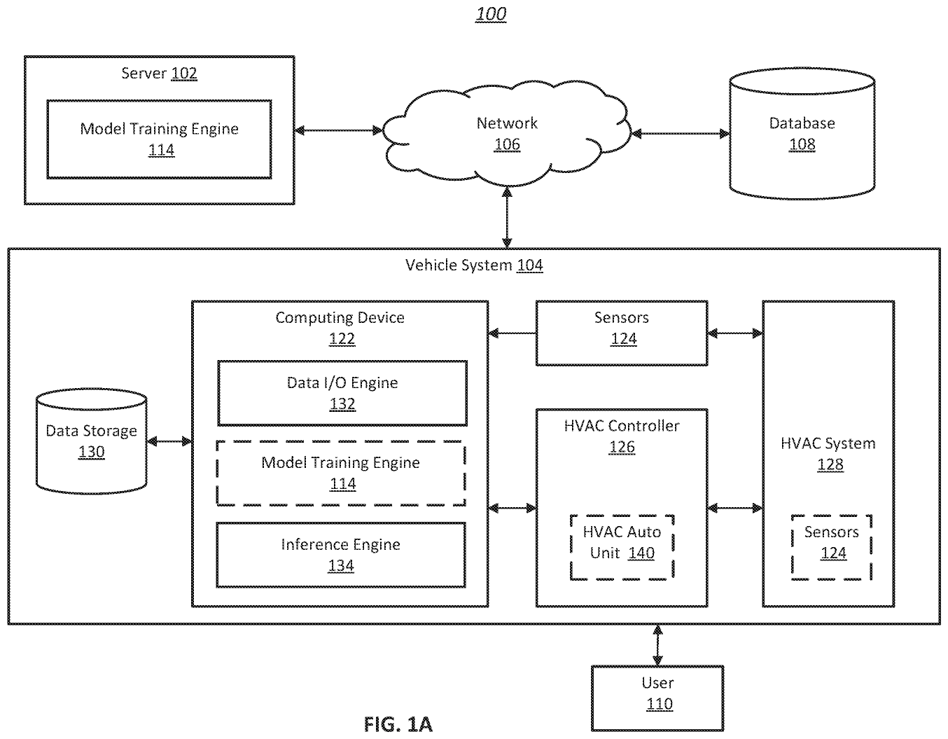

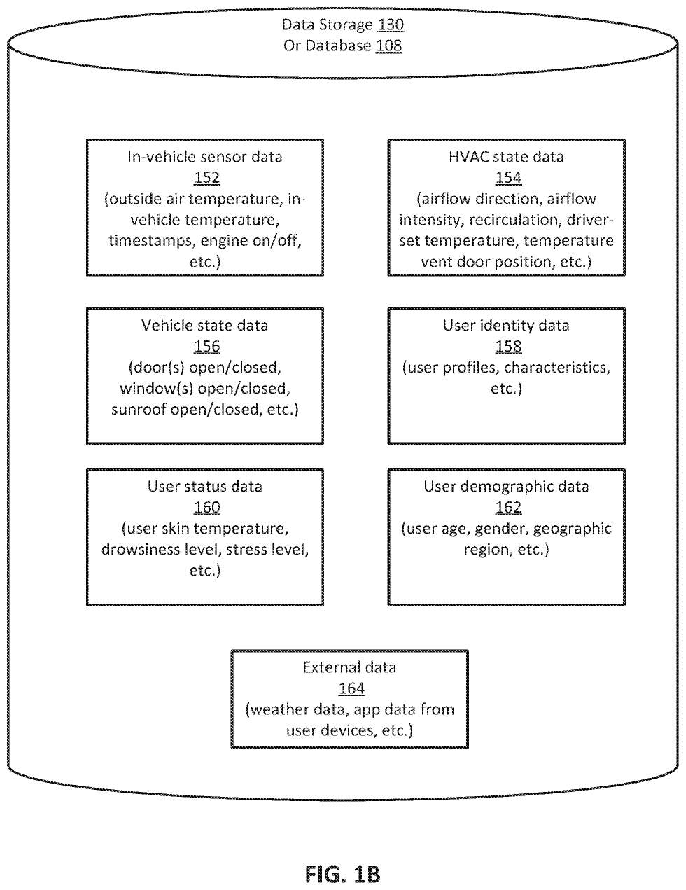

FIG. 1A illustrates an exemplary environment 100 for personalized HVAC control, consistent with exemplary embodiments of the present disclosure. As shown in FIG. 1A, the exemplary environment 100 may include a vehicle system 104 and other entities (e.g., a server 102 and a database 108) that may be connected with the vehicle system 104 through one or more networks, e.g., a network 106. The vehicle system 104 and the server 102 may communicate over the network 106 using one or more communication protocols, for example cellular, WiFi, and other communication protocols. While the server 102, the vehicle system 104, and the database 108 are shown in FIG. 1A as single entities, this is merely for ease of reference and is not meant to be limiting. The environment 100 may include multiple servers 102, vehicle systems 104 (collectively and individually referred to as 104), and databases 108.

The vehicle system 104 may include a computing device 122, sensors 124, a HVAC controller 126, a HVAC system 128, and a data storage 130. The computing device 122 may be connected with the other components of the vehicle system 104, e.g., the sensors 124, the HVAC controller 126 (optionally including a HVAC auto unit 140), and the data storage 130, to retrieve and/or transmit information from and/or to the other components so as to control the HVAC system 128 to provide a desired in-vehicle environment for occupants, e.g., a user 110 of the vehicle system 104. The computing device 122 may communicate with the server 102 over the network 106. The computing device 122 and the server 102 may include one or more processors and memory (e.g., permanent memory, temporary memory). The processor(s) may be configured to perform various operations by executing machine-readable instructions stored in the memory. The computing device 122 and the server 102 may include other computing resources and/or have access (e.g., via one or more connections/networks) to other computing resources.

While the computing device 122 is shown in FIG. 1A as a single entity, this is merely for ease of reference and is not meant to be limiting. In some embodiments, one or more components/functionalities of the computing device 122 described herein may be implemented in multiple computing devices. In some embodiments, one or more components/functionalities of the server 102 may be implemented in the computing device 122, or vice versa. In some embodiments, one or more components/functionalities of the computing device 122 described herein may be implemented by the HVAC controller 126 or the optional HVAC auto unit 140.

The HVAC system 128 may be a conventional HVAC system that provides heating, ventilation and air conditioning in a vehicle 104. For example, the HVAC system 128 may be positioned at the front end of a vehicle 104. In some embodiments, the HVAC system 128 may be equipped with one or more sensors 124 to measure states of the HVAC system 128. For example, the one or more sensors 124 in the HVAC system 128 may measure a position of a vent door. Other examples of the states of the HVAC system 128 which may be measured by the sensors 124 may include, but are not limited to, airflow direction or pattern (e.g., face, foot, window screen, etc.), airflow intensity, recirculation, driver-set temperature, etc.

The sensors 124 may also include other types of sensors 124 (e.g., external sensors, internal sensors, etc.) besides the sensors 124 used to sense the current states of the HVAC system 128. For example, the other types of sensors 124 may include temperature sensors for measuring outside air temperature and in-vehicle temperature, clock for recording time, and engine sensors for detecting engine on/off. Optionally, the sensors 124 may include a solar intensity sensor for sensing solar intensity, an engine speed sensor for measuring an engine speed, an engine revolutions per minute (RPM) sensor for sensing RPM, duct temperature(s) sensor(s) for measuring duct temperature(s), a heading sensor for detecting vehicle heading, etc. Further, the sensors 124 may include a Global Positioning System (GPS) to detect a current geolocation of the vehicle 104.

In some embodiments, the sensors 124 may include yet other types of sensors to detect states of the vehicle 104. For example, the sensors 124 may include a vehicle door sensor to detect if the one or more doors of the vehicle are open or closed. Other types of sensors 124 detecting the vehicle's 104 states may include window sensors for detecting if one or more windows of the vehicle 104 are open or closed, sunroof sensors for detecting if the sunroof of the vehicle is open or closed, etc. One skilled in the art may recognize other examples of sensors 124 for detecting states of the vehicle 104, e.g., sensors for measuring driving states of the vehicle 104 (moving, or parked), etc. Alternatively, the vehicle state data may be obtained from other sources or components of the vehicle 104. For example, when a user 110 opens a window the vehicle 104, the computing device 122 or other components of the vehicle 104 may detect and record the action.

In some embodiments, the sensors 124 may include the types of sensors that may capture a user's (e.g., a driver's, a passenger's, or another occupant's) 110 characteristics for identifying the user 110. These types of sensors may include a camera to capture a part of the user's 110 body (e.g., the user's 110 face), a biosensor to capture bio-information of the user 110 (e.g., a weight sensor on the seat to measure the weight of the user 110, a touch sensor on the driving wheel to capture a fingerprint of the user 110), etc. Optionally, the computing device 122 of the vehicle system 104 may include a software that may be configured to identify a user 110 (e.g., a driver or a passenger) in the vehicle 104 based on captured data associated with the user 110 by the sensors 124. For example, the computing device 122 may include a face recognition module to identify the user 110 based on one or more captured images or videos of the user's 110 face. Alternatively, the computing device 122 of the vehicle system 104 may identify the user 110 through connecting with or detecting a user device the user 110 carries or the server 102. A user device may include mobile phone, tablet, PC, wearable device (smart watch), etc. For example, once connected to the user device (based upon an authorization of the user 110), the computing device 122 of the vehicle system 104 may retrieve the user's 110 identify data from the user device or the server 102. In a further alternative scenario, the user device or the computing device 122 of the vehicle system 104 may allow the user 110 to input the user's 110 identity/profile information (e.g., a user name, account information, etc.).

Similarly, a user's 110 demographic data may also be obtained either by the computing device 122 (or another component) of the vehicle system 104 based on the data captured by cameras or biosensors 124 described above or through connecting to the user device carried by the user 110, or by user input through the user device or the computing device 122 of the vehicle system 104. The user's 110 demographic information may include age, gender, geographic region, etc. For example, the computing device 122 may request these data of the user 110 from the user device, and upon the user's 110 authorization, the computing device 122 may retrieve these data from the user device and store these data into the data storage 130. In some embodiments, the computing device 122 may also obtain other relevant data (also referred to as external data) to perform the functionalities described hereinafter. For example, the computing device 122 may collect weather data from public resources through the network 106. In another example, the computing device 122 may collect data stored in the user device, or obtain data associated with applications on the user device (e.g., a weather application, a map application, etc.).

In some embodiments, the sensors 124 (e.g., cameras, biosensors, etc.) may further be used to detect a user's status. For example, the sensors 124 may include a temperature sensor to detect a skin temperature of the user 110. In another example, the computing device 122 of the vehicle system 104 may analyze videos or images captured by the camera 124 to detect a drowsiness level of the user 110 (e.g., a driver) and/or a stress level of the user 110 (e.g., a driver, a passenger), etc. For example, computing device 122 may have eye-tracking software installed, and may, via the camera 124, tracks the user's eye movements to determine the user's drowsiness or stress level. In some embodiments, the sensors 124 (e.g., cameras, biosensors, etc.) may also be used to detect a user's 110 (e.g., a driver's, a passenger's) age, gender, geographic region, or other demographic data/information of the user 110.

Referring to FIG. 1B, an exemplary data storage 130 or database 108 is illustrated. The data storage 130 or database 108 may include in-vehicle sensor data 152 (describing environmental measurements), e.g., outside air temperature, in-vehicle temperature, timestamps, and engine on/off. Optionally, the in-vehicle sensor data 152 may also include solar intensity, engine speed, engine RPM, duct temperature(s), vehicle heading, geolocation of the vehicle 104, etc. The data storage 130 or database 108 may also store HVAC state data 154, e.g., airflow direction (face, foot, window screen, etc.), airflow intensity, recirculation, driver set temperature, vent door position, etc. Thus, the HVAC state data 154 may describe one or more states of the HVAC system 128. In some embodiments, the data storage 130 or database 108 may store the vehicle state data 156. The vehicle state data 156 may describe states of the vehicle 104, including, e.g., data indicating whether doors are open or closed, whether the windows are open or closed, whether the sunroof is open or closed, etc.

In some embodiments, the data storage 130 or database 108 may store the user identity data 158 describing an identity of the user 110, user status data 160 describing status of the user 110, and/or user demographic data 162 describing demographic information associated with the user 110. For example, these data 158, 160 and 162 associated with a user 110 may include the user's 110 characteristic, bio-information, images, a name, profile information, account information, skin temperatures, a drowsiness level, a stress level, age, gender, a geographic region, etc. In some embodiments, the data storage 130 or database 108 may also store the external data 164 describing any external information. The external data 164 may include weather data, app data from user devices, etc.

In some embodiments, the data storage 130 or database 108 may store historical in-vehicle sensor data 152, HVAC state data 154, vehicle state data 156, user identity data 158, user status data 160, user demographic data 162, and/or external data 164 retrieved by the computing device 122 over a period of time or a course of lifetime of the vehicle 104. These historical in-vehicle sensor data 152, HVAC state data 154, vehicle state data 156, user identity data 158, user status data 160, user demographic data 162, and/or external data 164 may be used by the computing device 122 or the server 102 as training data to generate one or more inference models to predict personalized target values for controlling the HVAC system 128. This is described in further detail below. In some embodiments, the one or more inference models may also be stored in the data storage 130 or in the database 108.

The HVAC controller 126 may be configured to control the operation of the HVAC system 128. In some embodiments, the HVAC controller 126 may be operable by the user 110 to turn on or off the HVAC system 128 (e.g., heating, ventilation, air conditioning), increase or decrease the intensity of the airflow, adjust the direction or pattern of the airflow, etc.

In some embodiments, the HVAC controller 126 may include a HVAC auto unit 140 to facilitate the automatic control of the HVAC system 128. In some embodiments, the HVAC auto unit 140 is software embedded on the HVAC controller 126 to achieve the automatic control functionality. In some embodiments, the HVAC auto unit 140 is a hardware device incorporated by the HVAC controller 126. In some embodiments, the HVAC auto unit 140 is firmware included by the HVAC controller 126. The HVAC auto unit 140 may be configured to be programmable by the user 110 and automatically turn on or off, or adjust the HVAC system 128 at certain times of a day or under certain environmental circumstances based on the user's 110 programming or setting. For example, the HVAC auto unit 140 may allow the user 110 to set a desired in-vehicle temperatures in the morning, at noon and night. The HVAC auto unit 140 may cooperate with the temperature sensor 124 to monitor the temperature inside the vehicle 104. When the temperature is higher or lower than the desired in-vehicle temperature set by the user 110 at a certain time, the HVAC auto unit 140 may control the HVAC system 128 to adjust the temperature to the desired value set by the user 110.

### Scenario I: Without a HVAC Auto Unit 140

In some embodiments, the computing device 122 may provide a personalized adaptive HVAC control for the vehicle 104 or for the user 110 of the vehicle 104 without a HVAC auto unit 140. In some embodiments, the computing device 122 may be configured to receive information from the sensors 124, the HVAC controller 126, a user device (not shown), and/or the server 102. The information may include the historical in-vehicle sensor data 152, HVAC state data 154, vehicle state data 156, user identity data 158, user status data 160, user demographic data 162, and/or external data 164. Based on the received information, the computing device 122 may generate and train a personal inference model for the vehicle system 104, or for a user 110 (e.g., a driver, a passenger, or any other occupants) of the vehicle 104 if the vehicle system 104 is equipped with components (not shown in FIG. 1A) to detect and identify a user 110 through technologies such as face recognition, bio-information detection, etc. The computing device 122 may predict a personal target value for the vehicle system 104 or for the user 110 of the vehicle system 104 using the trained personal inference model. The computing device 122 may output the predicted target value to the HVAC controller 126 to control the HVAC system 128 so as to provide a desired in-cabin environment of the vehicle system 104.

In some embodiments, the computing device 122 may be configured to send the received information from the sensors 124, the HVAC controller 126 and/or a user device to the server 102. The server 102 may also collect other related data, e.g., the external data 164. The server 102 may be configured to generate and train a personal inference model for a vehicle system 104 or a user 110 of the vehicle system 104 based on the received information from the vehicle system 104 and/or the collected external data 164. In some embodiments, the computing device 122 may periodically send updated information from the sensors 124, the HVAC controller 126 and/or the user device to the server 102. Responsively, the server 102 may further update the personal inference model for the vehicle system 104 or the user 110 of the vehicle system 104 based on the periodically received updated information from the vehicle system 104 and/or the collected external data 164. The server 102 may send the trained and/or updated personal inference model back to the vehicle system 104 and the vehicle system 104 may use the personal inference model to predict a target value for the vehicle system 104 or for the user 110 of the vehicle system 104.

In some embodiments, instead of generating a personal inference model, the server 102 may be configured to obtain information from sensors 124 and/or HVAC controllers 126 of a number of vehicles (same or similar to the vehicle system 104), user devices and/or other entities from a variety of resources. The server 102 may generate and train a general inference model for an average vehicle 104 or an average user 110 of a vehicle 104 based on the obtained information from a number of vehicles 104 and/or user devices. In some embodiments, multiple general inference models for different vehicles or different types of vehicles or user categories may be generated and stored in the data storage 130 or the database 108. For example, different general inference models may be generated for users 110 in different geographic regions, with one general inference model fits for the users 110 in a particular geographic region (e.g., California, or San Francisco, etc.). In another example, different general inference models may be created for users 110 in different age ranges. In a further example, different general inference models may be created for different types of vehicles (e.g., vehicles with sunroof and vehicles without sunroof).

One or more general inference models may be sent to a vehicle 104 according to different situations, to predict a general target value used to control the HVAC system 128. For example, based on the geographic region where the vehicle 104 drives, a corresponding general model for this geographic region may be sent to the vehicle 104. In another examples, if the user 110 of the vehicle 104 in California is detected to be 30-40 years old, a general model for California and a general model for a user 110 of the age range (e.g., 30-40 years old) may both be sent to the vehicle 104. Prediction results of the two general inference models may be combined to obtain a comprehensive general target value.

To achieve a personalized control, the server 102 may further generate and train a different type of personal inference model which may be used along with the general inference model for an average vehicle 104 or an average user 110 of a vehicle 104 (or one or more general inference models for the above-described different vehicle or user categories) to obtain a personalized target value. For example, the personal inference model may be used to predict a personal target adjustment value that indicates a difference of preference between a vehicle 104 and the average vehicle 104 or a difference of preference between a user 110 of the vehicle 104 and the average user 110 of vehicles 104. The personal inference model and the general inference model for an average vehicle 104 or an average user 110 of a vehicle 104 (or one or more general inference models for above-described different categories) may be sent to the vehicle system 104 and used to predict a general target value for an average vehicle 104 or an average user 110 of a vehicle 104 (or a general target value for a vehicle or user category, or a comprehensive general target value for certain categories) and a personal target adjustment for the vehicle 104 or a user 110 of the vehicle 104. For convenience of description, the general inference model for an average vehicle 104 or an average user 110 of a vehicle 104, and the one or more general inference models for different vehicle or user categories may be referred to as the general inference model, individually and collectively, hereinafter. In addition, the general target value for an average vehicle 104 or an average user 110 of a vehicle 104, the general target value for a vehicle or user category, and a comprehensive general target value for a number of categories may all be referred to as the general target value, individually and collectively, hereinafter.

The computing device 122 may combine the general target value and the personal target adjustment value to generate a personalized target value to control the HVAC system 128. For example, if the general inference model is used to predict a general target value of the in-vehicle temperature as 25° C., the personal inference model may be used to predict a user's 110 preference difference of +2° C. (e.g., the user 110 prefers two degree warmer than an average occupant of a vehicle 104). The combined personalized target value may be 25° C.+2° C.=27° C. In some embodiments, the computing device 122 may combine the general target value and the personal target adjustment value to obtain a weighted sum. For example, when a user starts to use a vehicle 104, the computing device 122 may assign a higher weight to the general target value. The reason of doing so is that in the early stage, there may not be enough training data (e.g., historical sensor data 152, and HVAC state data 154, vehicle state data 156, user identify data 158, user status data 160, and/or user demographic data 162 associated with a vehicle 104 or a user 110 of the vehicle 104, and/or external data 164). Therefore, the personal inference model may not completely reflect the preference of the vehicle 104 or the user 110 of the vehicle 104. After a predetermined period of time or after a predetermined amount of training data has been collected, the personal inference model may be trained to more reflect the preference of the vehicle 104 or the user 110 of the vehicle 104. In such a stage, the computing device 122 may assign a higher weight to the personal target adjustment value to reflect the preference of the vehicle 104 or the user 110.

Many other implementations for controlling the HVAC system 128 based on a personal inference model and/or a general inference model may be possible. In some embodiments, the server 102 may send the general inference model to the vehicle system 104 and the vehicle system 104 may update the general inference model based on the collected measurement data from the sensors 124, HVAC state data 154 from the HVAC controller 126, vehicle state data 156, user identify data 158, user status data 160, and/or user demographic data 162 and/or external data 164 during the use of the vehicle 104 to obtain a personal inference model along the path. The personal inference model may then be used to predict a personal target value for the vehicle 104 or a user 110 of the vehicle 104 to control the HVAC system 128 that provides a comfortable environment in the vehicle 104 or for the user 110.

### Scenario II: With a HVAC Auto Unit 140

In some embodiments, the HVAC controller 126 may include a HVAC auto unit 140 for automatic control of the HVAC system 128. In such a scenario, the server 102 may generate and train a HVAC auto unit inference model which may be used to predict actions of a HVAC auto unit 140 for a type of vehicle 104. For example, the server 102 may collect training data associated with a type of HVAC auto unit 140, e.g., sensor data 152, HVAC state data 154 associated with the type of HVAC auto unit 140 or the type of vehicle 104, vehicle state data 156, data associated users 158, 160 and 162 and/or external data 164 from a variety of resources, and train the HVAC auto unit inference model accordingly. The server 102 may send the HVAC auto unit inference model to the vehicle system 104. The computing device 122 of the vehicle system 104 may be configured to use the HVAC auto unit inference model to predict a general target value (e.g., a temperature, a wind pattern, an air flow intensity, AC on/off, recirculation on/off, etc.). Similar to Scenario I, the HVAC auto unit inference model may also include more than one type of models for different vehicle or user categories.

Further, similar to Scenario I, the server 102 may also generate and train a personal inference model for a vehicle 104 or a user 110 of the vehicle 104 based on retrieved history information from the sensors 124, the HVAC controller 126 and/or user devices. The personal inference model may also be sent to the computing device 122 of the vehicle system 104 to predict a personal target adjustment value for the vehicle 104 or the user 110 of the vehicle 104. The computing device 122 may combine the general target value and the personal target adjustment value to output a combined target value to adjust the HVAC auto unit 140 to control the HVAC system 128.

Alternatively, the personal inference model may be generated and trained by the computing device 122 for the vehicle 104 or the user 110 of the vehicle 104 based on retrieved history information from the sensors 124, the HVAC controller 126 and/or user devices. The computing device 112 may periodically update the personal inference model using updated information retrieved from the sensors 124 and/or the HVAC controller 126 to accurately match the preference of the vehicle 104 or the user 110 of the vehicle 104. The computing device 112 may use the personal inference model to predict a personal target adjustment value for the vehicle 104 or the user 110 of the vehicle 104. In some embodiments, the personal target adjustment value may be used to adjust the target value of the HVAC auto unit 140 which may control the HVAC system 128. In such a way, the target value produced by the HVAC auto unit 140 may be personalized by the personal target adjustment value and reflect the preference of the vehicle 104 or the user 110 of the vehicle 104.

### Computing Device 122

The computing device 122 may include a data input/output (I/O) engine 132 and an inference engine 134. Optionally, the computing device 122 may also include a model training engine 114. Alternatively, the model training engine 114 may reside on the server 102. The components of the computing device 122 shown in FIG. 1A and presented below are intended to be illustrative.

The data I/O engine 132 may be configured to retrieve the information from the sensors 124 and/or the HVAC controller 126. In some embodiments, the data I/O engine 132 may also transform the information from the sensors 124, the HVAC controller 126 and/or user devices into requisite format for the model training engine 114 and the inference engine 134. For example, the data I/O engine 132 may map categories (e.g., wind patterns such face, foot, etc.) to numerical values (e.g., 1, 2, etc.) to facilitate the training of the one or more inference models. In some embodiments, the data I/O engine 132 may filter the data 152, 154 to remove non-reliable data. In some embodiments, the data I/O engine 132 may scale the data 152, 154 to an appropriate range of values. Other processing or mathematical transformation of the data 152, 154 may also be performed by the data I/O engine 132 according to various embodiments. In addition, the data I/O engine 132 may transform the output of the inference engine 134 into a requisite form of a HVAC target signal/value for the HVAC controller 126 to control the HVAC system 128.

The model training engine 114 may be configured to create, train and update one or more inference models based on the historical information from the sensors 124, the HVAC controller 126 and/or the user devices. In some embodiments, a target value to be predicted may be a continuous variable. For example, a target value is a temperature ranging from 18° C.-30° C. In another example, a target value is an intensity of wind. In such cases, the model training engine 114 may utilize regression analysis technique to model the relationship between independent variables (e.g., the in-vehicle sensor data 152 and HVAC state data 154) and the dependent or target control variables. The model training engine 114 may train the model of the relationship by using the retrieved historical in-vehicle sensor data 152, HVAC state data 154, vehicle state data 156, user identity data 158, user status data 160, user demographic data 162, and/or external data 164 as training data. The one or more inference models may be regression models.

In some embodiments, a target value to be predicted may be a discrete variable. For example, a control variable is a wind pattern chosen from the types of face, foot, face and foot, window screen, etc. In such cases, the model training engine 114 may utilize classification technique to model the relationship between the independent variables (e.g., the in-vehicle sensor data 152, HVAC state data 154, vehicle state data 156, user identity data 158, user status data 160, user demographic data 162, and/or external data 164) and the target classifications. The classification inference models may be also trained based on the retrieved training data, and output a category from a known set.

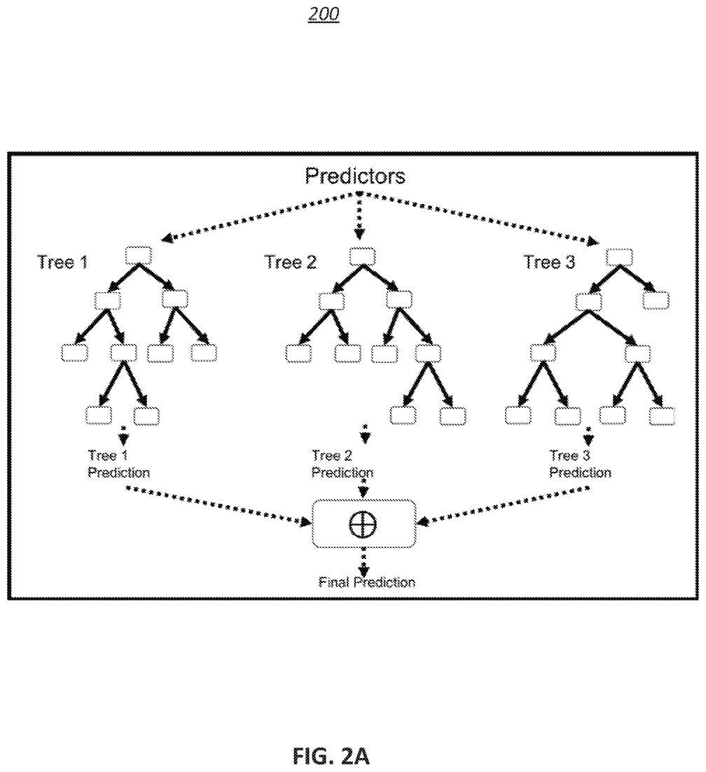

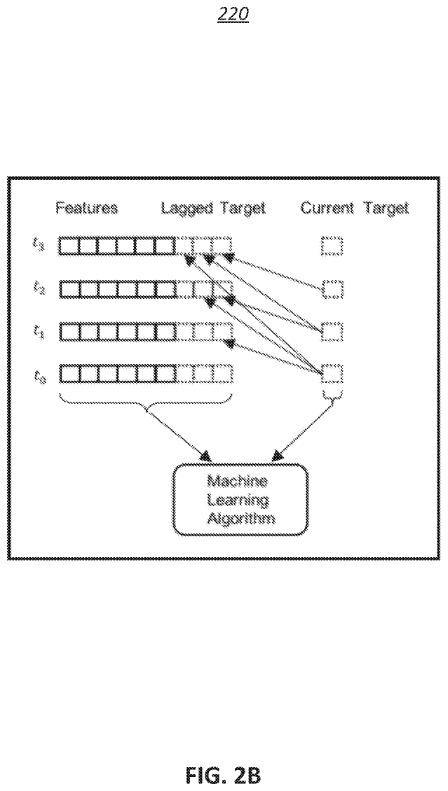

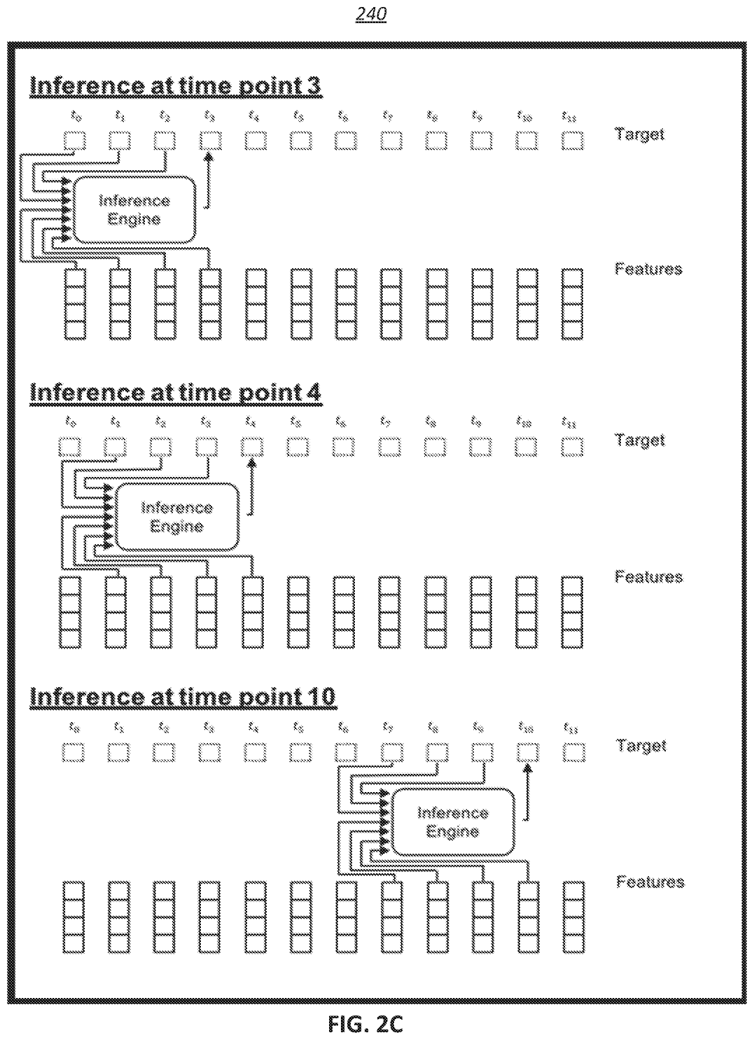

Examples of machine learning algorithms may include, but are not limited to, linear regression, nonlinear regression (e.g., polynomial regression), decision trees, gradient boosted trees, random forests, neural networks, etc. Referring to FIG. 2A, a diagram 200 of Gradient Boosted Trees is illustrated in accordance with various embodiments. Gradient Boosted Trees are one type of machine learning algorithm used to solve regression and classification problems. A set of predictors (e.g., features) may be defined based on the training data. An ensemble of weak prediction models (e.g., Tree 1, Tree 2, and Tree 3) may be produced. Predictions of the multiple weak prediction models may be summed to obtain the final prediction. In some embodiments, the weak prediction models are taken to be decision trees (e.g., Tree 1, Tree 2, and Tree 3). Each node of each tree induces a split on a single feature, resulting in a tree that maps each feature vector to single tree leaf. Each leaf is associated with a value of the target variable. Boosting is applied during model training in which additional trees trained on the residual errors of the prior collection of trees are added sequentially until a stopping criterion is reached.

Referring to FIG. 2B, illustrated is a diagram 220 of model training in a mixed autoregressive context, in accordance with various embodiments. In the illustrated embodiments of FIG. 2B, a machine learning algorithm (e.g., an inference model) may be trained in a mixed autoregressive context. For example, at each time point, e.g., t₀, t₁, t₂, t₃, samples of features (represented by solid blocks in FIG. 2B) at current and previous time points, and samples of lagged target values (represented by dotted blocks following the solid blocks in FIG. 2B) are mapped by the machine learning algorithm (e.g., the inference model) to current target values (represented by single dotted block at each row in FIG. 2B). The features may be current state of sensor data values, user data values and/or external data values (also referred to as “current features”) and historical states of the sensor data values, user data values and/or external data values (also referred to as “time lagged features” or “lagged features”). For example, the sensor data values may include the values of in-vehicle sensor data 152, HVAC state data 154 and vehicle state data 156. The user data values may include the values of user identity data 158, user status data 160 and user demographic data 162. The external data values may be the values of the external data 164. The lagged target values may be historical HVAC state target values predicted at previous time points. During the training, the current HVAC state target values may be the ones set by the user 110 or controlled by the HVAC controller 126 (e.g., including the HVAC auto unit 140). These data values are used to train one or more inference models. In some embodiments, one inference model may be generated for one target. In other embodiments, one inference model may be generated for multiple targets. The targets may include a temperature (e.g., a driver-set temperature), a wind pattern (e.g., face, foot, etc.), a wind intensity or level, AC on/off, recirculation on/off, etc.

In some embodiments, instead of using historical states of the target value predicted at previous time points along with the features at the current time point to train the inference models (which are referred to as “feedback models”), target values set by the user 110 or controlled by the HVAC controller 126 (e.g., including the HVAC auto unit 140) at the previous time points (which are also referred to as “true target values”) may be used as input to train the inference models (which are referred to as “non-feedback models” or “true value models”). In addition, although in the illustrated embodiments of FIG. 2B three lagged target values are used to train the feedback inference models, a different number of lagged target values may be used. Furthermore, to train the true value models, any suitable number of historical true target values may be used.

FIG. 2C illustrates a diagram 240 of inference based on the trained inference model, in accordance with various embodiments. In the illustrated embodiments, the trained model predicts the current state of the target using a set of predictors (or inputs) including the current features, lagged features and the historical states of the target value. At each time point, e.g., t₀-t₁₁, the inference may be based upon a number of historical states of the target value predicted at previous time points. For example, the inference at each time point may be calculated using the last three historical states of the target value as well as features (e.g., the current features, lagged features). One skilled in the art should appreciate that the number three is only illustrative, but not meant to be limiting. A different number of historical states of the target value may be used to predict the current state of the target value. Similarly, at each time point, t₀-t₁₁, the inference may be calculated also based on the lagged features at the last three time points in addition to the current feature and lagged target values. Again, One skilled in the art should appreciate that the number three is only illustrative, but not meant to be limiting. A different number of lagged features may be used to predict the current state of the target value.

Specifically, the target value at time t₃ may be inferred based on the historical states of the target value at time points t₀, t₁, t₂, and lagged features at the time points t₀, t₁, t₂, as well as the current features at time point t₃. Similarly, the target value at time t₄ may be inferred based on the historical states of the target value at time points t₁, t₂, t₃, and lagged features at the time points t₁, t₂, t₃, as well as the current features at time point t₄. The inference may continue, and the target value at time t₁₀ may be inferred based on the historical states of the target value at time points t₇, t₈, t₉, and lagged features at the time points t₇, t₈, t₉, as well as the current features at time point t₁₀. One skilled in the art should appreciate that the three time points are only illustrative, but not meant to be limiting. More or less time points may be possible according to different embodiments.

In some embodiments, corresponding to the training stage described with reference to FIG. 2B, instead of using lagged target value predicted at previous time points, target values set by the user 110 or controlled by the HVAC controller 126 (e.g., including the HVAC auto unit 140) at the previous time points (e.g., true target values) may be used as input to the true value model to predict a current state of the target value.

In some embodiments, the model training engine 114 may generate different types of inference models to facilitate the personalized control of the HVAC system 128. As disclosed above with reference to the Scenarios I and II, the model training engine 114 may be configured to generate a general inference model for an average vehicle 104 or an average user 110 of a vehicle 104 based on history information obtain from sensors 124 and/or HVAC controllers 126 of a number of vehicles (same or similar to the vehicle system 104) user devices and/or other entities from a variety of resources. In addition, the model training engine 114 may be configured to generate a personal inference model for a vehicle system 104 or a user 110 of the vehicle system 104 based on the received sensor data 152 and/or HVAC state data 154 from the vehicle system 104, and/or user devices. Further, in some embodiments, the model training engine 114 may generate a HVAC auto unit inference model that may be used to predict a general target value of the HVAC auto unit 140.

In some embodiments, the model training engine 114 may generate different inference models for different target values. For example, the model training engine 114 may generate and train an inference model for the wind level or airflow intensity. The model training engine 114 may generate and train another inference model for wind pattern (e.g., face, foot, etc.). Additionally, the model training engine 114 may generate and train yet another inference model for the in-vehicle temperature. In some embodiments, the model training engine 114 may generate and train one inference model for different target values including wind level, intensity and pattern, in-vehicle temperature, etc.

The inference engine 134 may be configured to obtain a target signal or value by using the one or more inference models. In some embodiments, the inference engine 134 may apply presently retrieved sensor data 152, HVAC state data 154, vehicle state data 156, user identity data 158, user status data 160, user demographic data 162, and/or external data 164 to the personal inference model to obtain a personalized target value or signal. Such target value or signal may be processed by the data I/O engine 132 to be in an appropriate format and outputted to the HVAC controller 126 to control the HVAC system 128 to provide a desired in-vehicle environment of the vehicle 104 or for the user 110 of the vehicle 104. Alternatively, the inference engine 134 may apply the sensor data 152, HVAC state data 154, vehicle state data 156, user identity data 158, user status data 160, user demographic data 162, and/or external data 164 to both a general inference model and a personal inference model to obtain a general target value and a personal adjustment. The inference engine 134 may combine the general target value and the personal adjustment to obtain a personalized target value. Similarly, such a personalized target value may be processed by the data I/O engine 132 and sent to the HVAC controller 126 to achieve the personalized control of the HVAC system 128.

In some embodiments, when the vehicle system 104 includes a HVAC auto unit 140 for automatic control of the HVAC system 128, the inference engine 134 may apply presently retrieved sensor data 152, HVAC state data 154, vehicle state data 156, user identity data 158, user status data 160, user demographic data 162, and/or external data 164 to the HVAC auto unit inference model to obtain a general target value of the HVAC auto unit 140. The inference engine 134 may integrate the general target value of the HVAC auto unit 140 with the personal target adjustment to obtain a user-preferred target value of the user 110. Again, such a user-preferred target value may be processed by the data I/O engine 132 and sent to the HVAC controller 126 to control of the HVAC system 128 to automatically provide a user-preferred in-vehicle environment.

### Work Flows of Personalized HVAC Control

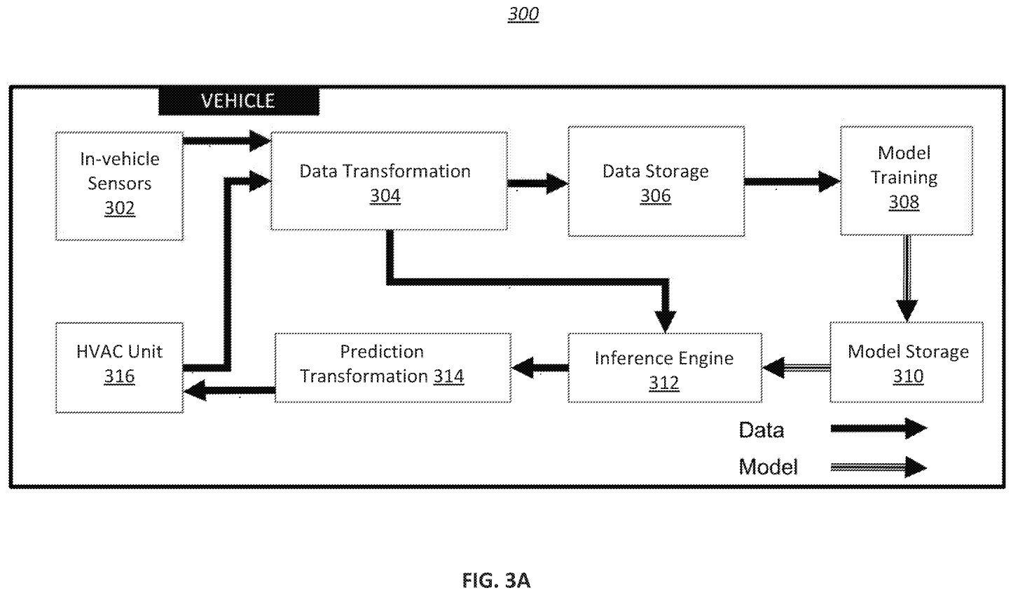

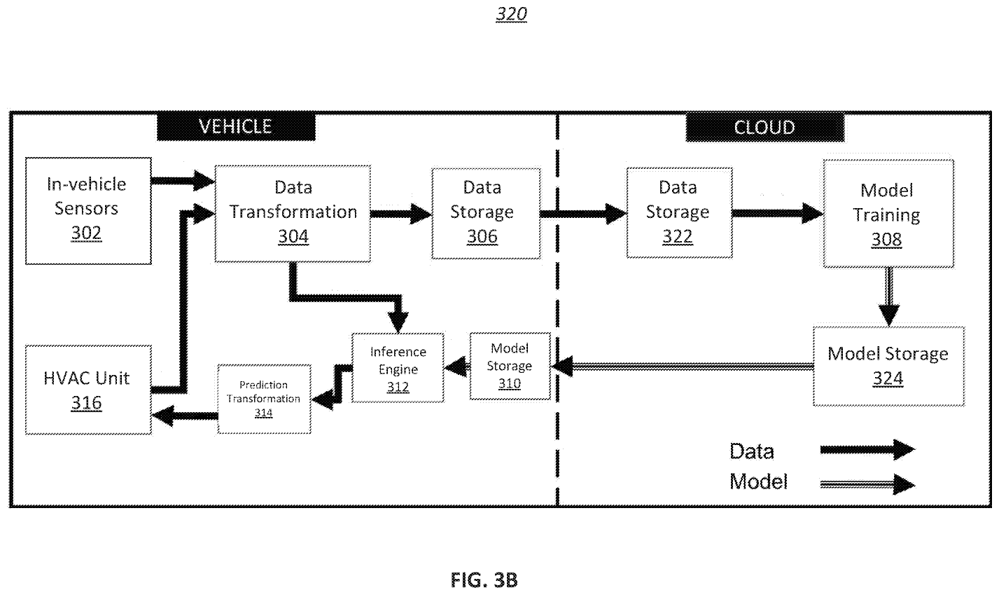

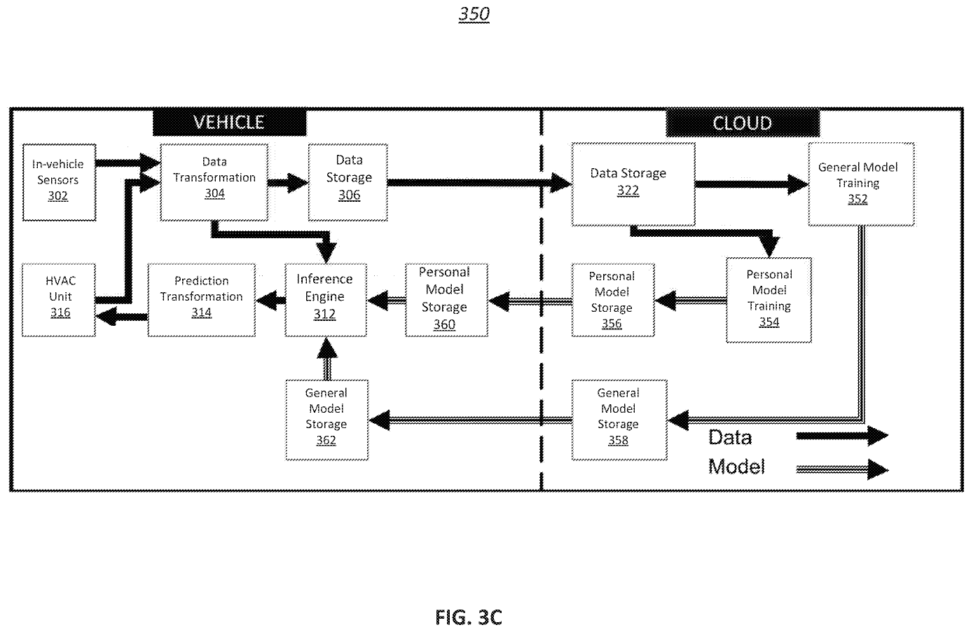

Referring to FIG. 3A, illustrated is an exemplary work flow 300 of the personalized HVAC control, in accordance with various embodiments. In the illustrated embodiments of FIG. 3A, the current and historical in-vehicle sensor data 152 (and/or other types of data as described with reference to FIG. 1B) may be retrieved from in-vehicle sensors 302 (e.g., the in-vehicle sensors may be the sensors 124 in FIG. 1A). The current and historical HVAC state data 154 may be retrieved from a HVAC unit 316 (e.g., the HVAC unit 316 may include the HVAC controller 126 or the HVAC auto unit 140 in FIG. 1A). These in-vehicle sensor data 152 (and/or other types of data as described with reference to FIG. 1B) and HVAC state data 154 may be transmitted to a data transformation component 304 (e.g., the data I/O engine 132 in FIG. 1A). In some embodiments, the data transformation component 304 may process the data 152, 154 to an appropriate format for being used as training data to train the one or more inference models, or for being used as input to an inference engine 312 (e.g., the interference engine 134 in FIG. 1A). For example, the data transformation component 304 may map categories (e.g., wind patterns such face, foot, etc.) to numerical values (e.g., 1, 2, etc.) to facilitate the training of the one or more inference models. In some embodiments, the data transformation component 304 may filter the data 152, 154 to remove non-reliable data. In some embodiments, the data transformation component 304 may scale the data 152, 154 to an appropriate range of values. Other processing or mathematical transformation of the data 152, 154 may also be performed by the data transformation component 304 according to various embodiments.

The processed sensor data and HVAC state data (and/or other types of data as described with reference to FIG. 1B) may be stored in a data storage 306 (e.g., the data storage 130 in FIG. 1A). The processed sensor data and HVAC state data may be further transmitted to a model training component 308 (e.g., the model training engine 114 residing on the vehicle system 104 in FIG. 1A). The model training component 308 may train the one or more inference models using a machine learning algorithm described above with reference to FIG. 1A and FIGS. 2A-2C. In some embodiments, the one or more inference models may include a personal inference model. The model training component 308 may store the one or more trained inference models in a model storage 310 (e.g., the data storage 130 in FIG. 1A). The one or more trained inference models may be transmitted to the inference engine 312. The inference engine 312 may also receive current in-vehicle sensor data 152 from the data transformation component 304. The inference engine 312 may input the current in-vehicle sensor data 152 (and/or historically predicted target value) to the one or more trained inference models to predict one or more target values. The one or more target values may be sent to a prediction transformation component 314 (e.g., the data I/O engine 132 in FIG. 1A). The prediction transformation component 314 may transform the one or more target values to an appropriate format and sent them to the HVAC unit 316 (e.g., the HVAC controller 126 or the HVAC auto unit 140) to control an in-vehicle HVAC system (e.g., the HVAC system 128).

FIG. 3B illustrates another exemplary work flow 320 of the personalized HVAC control, in accordance with various embodiments. The work flow 320 is the same as the work flow 300 as described with reference to FIG. 3A, except that in the work flow 320, another data storage 322 and a model storage 324 may be included in the server 102 in a cloud computing context. For example, these storages 322 and 324 may include the database 108 in FIG. 1A. In some embodiments, the data storage 306 in the vehicle system 104 may store recent in-vehicle sensor data 152 and HVAC state data 154 (and/or other types of data as described with reference to FIG. 1B), e.g., data for the most recent day, the most recent week, etc.; while the data storage 322 in the server 102 may store historical in-vehicle sensor data 152 and HVAC state data 154 (and/or other types of data as described with reference to FIG. 1B), e.g., data for the past month, the past year, the past five years, etc. Similarly, the model storage 324 in the server 102 may store historical inference models, while the model storage 310 in the vehicle 104 may store more up-to-date inference models. Additionally, in the illustrated embodiments of work flow 320, the model training component 308 is included in the server 102. The one or more inference models including a personal inference model may be trained by the model training component 308 in the server 102, and transmitted to the vehicle system 104.

FIG. 3C illustrates yet another exemplary work flow 350 of the personalized HVAC control, in accordance with various embodiments. The work flow 350 is similar to the work flow 320 as described with reference with FIG. 3B, except that in the work flow 350, two types of inference models—personal inference model(s) and a general inference model(s) may be trained by a general model training component 352 and a personal model training component 354 in the server 102 respectively. These two types of models have been described in detail with reference to FIG. 1A. The two model training components 352, 354 may be the model training engine 114 in the server 102. The personal inference model(s) and general inference model(s) may be stored at a general model storage 356 and a personal model storage 358 in the cloud respectively. The two model storages 356, 358 may include the database 108 in FIG. 1A. The two types of models may both be sent to the vehicle system 104. Correspondingly, a personal model storage 360 and a general model storage 362 in the vehicle system 104 may be used to store a part or all of the two types of models respectively. For example, the personal model storage 360 and general model storage 362 in the vehicle system 104 may store the most updated models.

Similar to the work flows 300 and 320, the two types of models may be used to predict a general target value for an average vehicle or an average user of a vehicle and a personal adjustment for the vehicle 104 or a user 110 of the vehicle 104. The general target value and the personal adjustment value may be combined to generate a personalized target value to control the HVAC system 128.

### Exemplary Methods

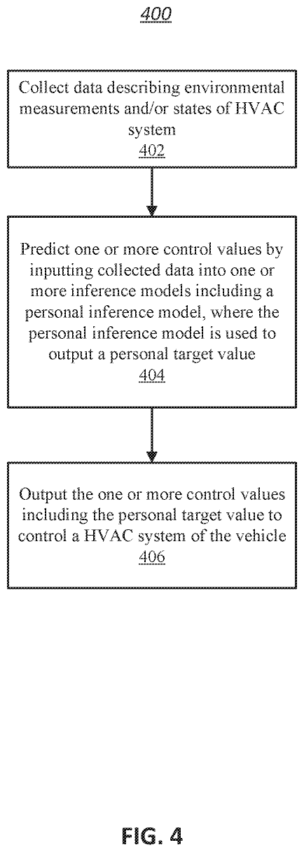

FIG. 4 illustrates a flowchart of an exemplary personalized HVAC control method 400, in accordance with various embodiments. The method 300 may be implemented in various systems including, for example, the environment 100 of FIG. 1A. The exemplary method 400 may be implemented by one or more components of the computing device 122 and/or server 102. The method 400 may be implemented by multiple systems similar to the environment 100. The operations of method 400 presented below are intended to be illustrative. Depending on the implementation, the exemplary method 400 may include additional, fewer, or alternative steps performed in various orders or in parallel.

At block 402, data describing environmental measurements and/or states of the HVAC system 128 may be collected. At block 404, one or more target values may be predicted by inputting collected data into one or more inference models including a personal inference model, where the personal inference model is used to output a personal target value for the vehicle 104 or a user 110 of the vehicle 104. At block 406, the one or more target values including the personal target value for the vehicle 104 or a user 110 of the vehicle 104 may be outputted to control the HVAC system 128 of the vehicle 104.

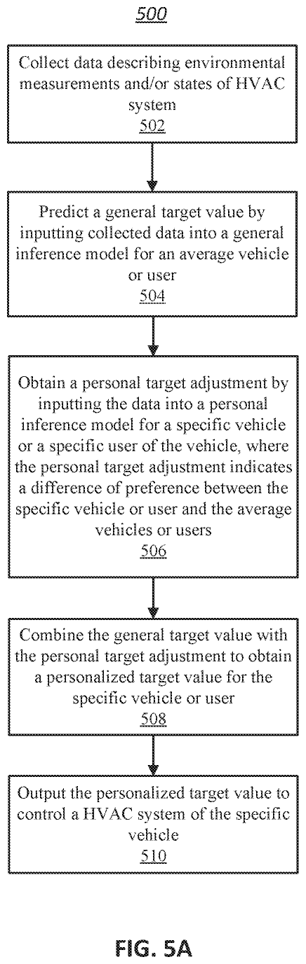

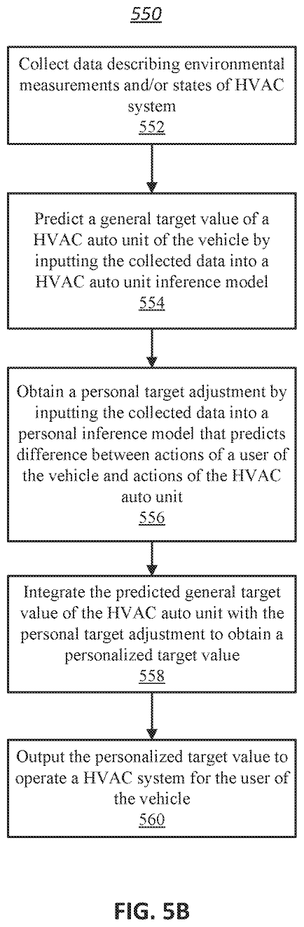

FIG. 5A illustrates a flowchart of another exemplary personalized HVAC control method 500, in accordance with various embodiments. The method 500 may be implemented in various systems including, for example, the environment 100 of FIG. 1A. The exemplary method 500 may be implemented by one or more components of the computing device 122 and/or server 102. The method 500 may be implemented by multiple systems similar to the environment 100. The operations of method 500 presented below are intended to be illustrative. Depending on the implementation, the exemplary method 500 may include additional, fewer, or alternative steps performed in various orders or in parallel.

At block 502, similar to the method 400, data describing environmental measurements and/or states of the HVAC system 128 may be collected. At block 504, a general target value may be predicted by inputting the collected data into a general inference model for an average vehicle 104 or an average user 110 of a vehicle 104. At block 506, a personal target adjustment may be obtained by inputting the collected data into a personal inference model for a vehicle 104 or a user 110 of the vehicle 104, where the personal target adjustment indicates a difference of preference between the vehicle 104 or a user 110 of the vehicle 104 and an average vehicle 104 or an average user 110. For example, the personal target adjustment may be the difference between a general target value, e.g., an in-vehicle temperature for an average user 110, and a preferred target value, e.g., a user-preferred in-vehicle temperature for a user 110 of a vehicle 104. For example, the user 110 may prefer a cooler in-vehicle temperature, such as one degree cooler, than the temperature desired by an average user 110.

At block 508, the general target value may be combined with the personal target adjustment to obtain a personalized target value for the vehicle 104 or the user 110 of the vehicle 104. In the above example, the personalized target value may be obtained by decreasing one degree from the general target value of the temperature. At block 510, the personalized target value may be outputted to control a HVAC system 128 of the vehicle 104.

FIG. 5B illustrates a flowchart of yet another exemplary personalized HVAC control method 550, in accordance with various embodiments. The method 550 may be implemented in various systems including, for example, the environment 100 of FIG. 1A. The exemplary method 550 may be implemented by one or more components of the computing device 122 and/or server 102. The method 550 may be implemented by multiple systems similar to the environment 100. The operations of method 550 presented below are intended to be illustrative. Depending on the implementation, the exemplary method 550 may include additional, fewer, or alternative steps performed in various orders or in parallel.

At block 552, similar to methods 400 and 500, data describing environmental measurements and/or states of the HVAC system 128 may be collected. At block 554, a general target value of an average HVAC auto unit 140 of the vehicle 104 may be predicted by inputting the collected data into a HVAC auto unit inference model. At block 556, a personal target adjustment may be obtained by inputting the collected data into a personal inference model that indicates a difference between actions or behaviors of a user 110 of a vehicle 104 and actions of an average HVAC auto unit 140. For example, the personal inference model may be used to predict a difference between the general target value of an average HVAC auto unit 140 of a type of vehicle 104 and a preferred target value of the user 110 upon the HVAC auto unit 140 of the vehicle 104.

At block 558, the predicted general target value of the HVAC auto unit 140 may be integrated with the personal target adjustment to obtain a personalized target value. At block 560, the personalized target value may be outputted to operate the HVAC system 128 of the vehicle 104 for the user 110.

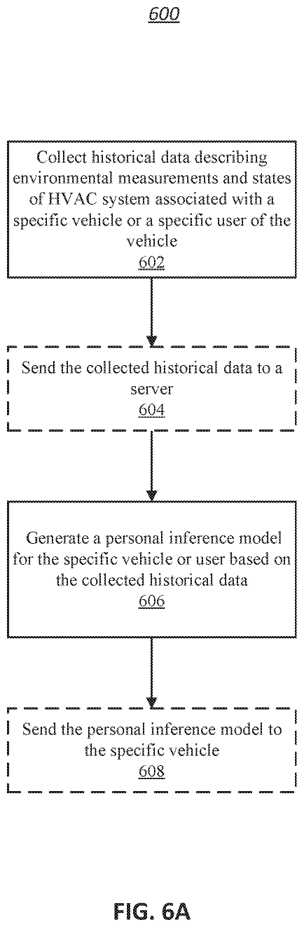

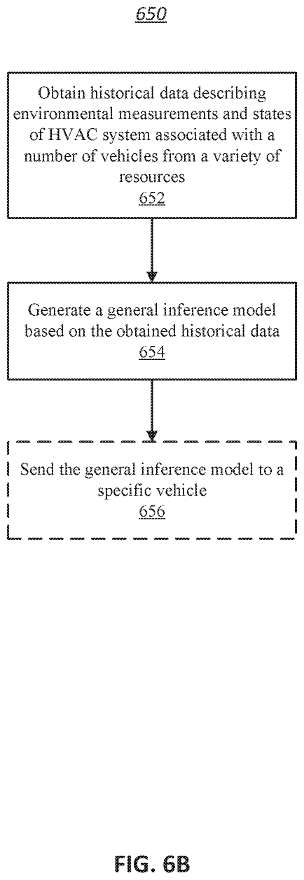

FIG. 6A illustrates a flowchart of an exemplary method 600 for generating a personal inference model for a vehicle 104 or user 110, in accordance with various embodiments. The method 600 may be implemented in various systems including, for example, the environment 100 of FIG. 1A. The exemplary method 600 may be implemented by one or more components of the computing device 122 and/or server 102. The method 600 may be implemented by multiple systems similar to the environment 100. The operations of method 600 presented below are intended to be illustrative. Depending on the implementation, the exemplary method 600 may include additional, fewer, or alternative steps performed in various orders or in parallel.

At block 602, historical data describing environmental measurements and the states of the HVAC system 128 associated with a vehicle 104 or a user 110 of the vehicle 104 may be collected. At block 604, optionally, the collected historical data may be sent to the server 102. Such collected historical data may be used as training data to train a personal inference model on the server 102. At block 606, a personal inference model for the vehicle 104 or the user 110 of the vehicle 104 may be generated based on the collected historical data. At block 608, optionally, the personal inference model may be sent from the server 102 to the vehicle 104 if the personal inference model has been generated and trained on the server 102 as indicated at block 604.

FIG. 6B illustrates a flowchart of an exemplary method 650 for generating a general inference model for an average vehicle 104 or an average user 110, in accordance with various embodiments. The method 650 may be implemented in various systems including, for example, the environment 100 of FIG. 1A. The exemplary method 650 may be implemented by one or more components of the computing device 122 and/or server 102. The method 650 may be implemented by multiple systems similar to the environment 100. The operations of method 650 presented below are intended to be illustrative. Depending on the implementation, the exemplary method 650 may include additional, fewer, or alternative steps performed in various orders or in parallel.

At block 652, historical data describing environmental measurements and states of the HVAC system 128 associated with a number of vehicles 104 may be obtained from a variety of resources. At block 654, a general inference model may be generated based on the obtained historical data. At block 656, optionally, the general inference model may be sent from a server 102 to a vehicle 104.

The techniques described herein are implemented by one or more special-purpose computing devices. The special-purpose computing devices may be desktop computer systems, server computer systems, portable computer systems, handheld devices, networking devices or any other device or combination of devices that incorporate hard-wired and/or program logic to implement the techniques. Computing device(s) are generally controlled and coordinated by operating system software. Conventional operating systems control and schedule computer processes for execution, perform memory management, provide file system, networking, I/O services, and provide a user interface functionality, such as a graphical user interface (“GUI”), among other things.

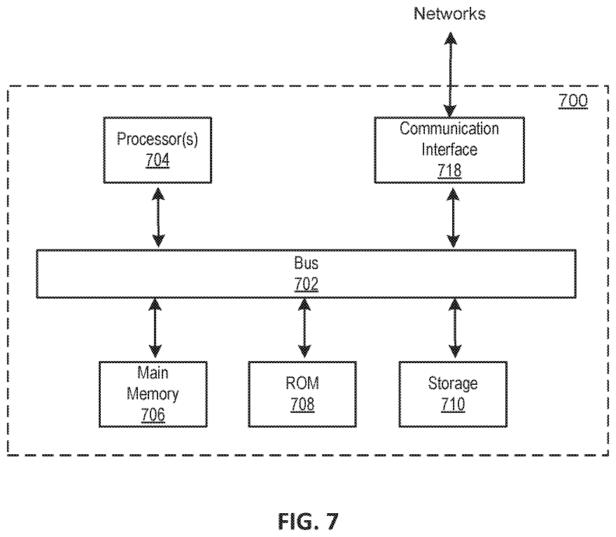

FIG. 7 is a block diagram that illustrates an exemplary computer system 700 in which any of the embodiments described herein may be implemented. The system 700 may correspond to the computing device 122 or the server 102 described above. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions. The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the operations, methods, and processes described herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The main memory 706, the ROM 708, and/or the storage 710 may include non-transitory storage media. The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 700 also includes a communication interface 718 coupled to bus 702. Communication interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN (or WAN component to communicated with a WAN). Wireless links may also be implemented. In any such implementation, communication interface 718 sends and receives electrical, electromagnetic or optical signals that carry digital data streams representing various types of information.

The computer system 700 can send messages and receive data, including program code, through the network(s), network link and communication interface 718. In the Internet example, a server might transmit a requested code for an application program through the Internet, the ISP, the local network and the communication interface 718. The received code may be executed by processor 704 as it is received, and/or stored in storage device 710, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

The various operations of example methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function, but can learn from training data to make a predictions model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A method for controlling a HVAC system of a vehicle, comprising:
collecting data describing environmental measurements and one or more states of the HVAC system;
predicting one or more target values by inputting the collected data into one or more inference models that include a personal inference model, wherein the personal inference model is used to predict a personal target value for the vehicle or a user of the vehicle; and
outputting the one or more target values including the personal target value for the vehicle or the user of the vehicle to control the HVAC system of the vehicle.

2. The method of claim 1, wherein the one or more inference models comprise a general inference model used to obtain a general target value for an average vehicle or an average user of vehicles, and wherein predicting one or more target values further comprises:
predicting the general target value for the average vehicle or the average user of vehicles by inputting the collected data into the general inference model,
wherein the personal target value is a personal target adjustment indicating a difference of preference between the vehicle and the average vehicle or a difference of preference between the user of the vehicle and the average user of vehicles.

3. The method of claim 2, further comprises:
combining the general target value and the personal target adjustment to obtain the one or more target values to control the HVAC system of the vehicle.

4. The method of claim 1, wherein the HVAC system comprises an HVAC auto unit for controlling the HVAC system, and wherein the one or more inference models comprise a HVAC auto unit inference model used to predict a general target value of the HVAC auto unit, wherein the personal target value is a personal target adjustment that indicates a difference between the general target value of the HVAC auto unit and a preferred target value of the user of the vehicle upon the HVAC auto unit.

5. The method of claim 4, further comprises:
combining the general target value of the HVAC auto unit and the personal target adjustment to obtain the one or more target values to control the HVAC system of the vehicle.

6. The method of claim 1, further comprises:
collecting historical data describing environmental measurements and one or more states of the HVAC system associated with the vehicle or the user of the vehicle; and
generating the personal inference model for the vehicle or the user of the vehicle based on the historical data.

7. The method of claim 1, wherein the one or more inference models are trained by using the data describing environmental measurements and one or more states of the HVAC system collected at a current time, lagged target values inferred at one or more previous times, and a current target value at the current time as training data.

8. The method of claim 7, wherein the current target value at the current time is set by the user or controlled by a HVAC controller of the HVAC system.

9. The method of claim 1, wherein collecting data describing environmental measurements and one or more states of the HVAC system comprises:
collecting additional data comprising one or more of vehicle state data describing one or more states of the vehicle, user identity data describing an identity of the user, user status data describing status of the user, user demographic data describing demographic information associated with the user, and external data describing external information.

10. A system for controlling a HVAC system of a vehicle, comprising
a processor; and
a non-transitory computer-readable storage medium storing instructions that, when executed by the processor, cause the system to perform a method for controlling a HVAC system of a vehicle, the method comprising:
collecting data describing environmental measurements and one or more states of the HVAC system;
predicting one or more target values by inputting the collected data into one or more inference models that include a personal inference model, wherein the personal inference model is used to predict a personal target value for the vehicle or a user of the vehicle; and
outputting the one or more target values including the personal target value for the vehicle or the user of the vehicle to control the HVAC system of the vehicle.

11. The system of claim 10, the one or more inference models comprise a general inference model used to obtain a general target value for an average vehicle or an average user of vehicles, and wherein predicting one or more target values further comprises:
predicting the general target value for the average vehicle or the average user of vehicles by inputting the collected data into the general inference model,
wherein the personal target value is a personal target adjustment indicating a difference of preference between the vehicle and the average vehicle or a difference of preference between the user of the vehicle and the average user of vehicles.

12. The system of claim 11, wherein the method further comprises:
combining the general target value and the personal target adjustment to obtain the one or more target values to control the HVAC system of the vehicle.

13. The system of claim 10, wherein the HVAC system comprises a HVAC auto unit for controlling the HVAC system, and wherein the one or more inference models comprise a HVAC auto unit inference model used to predict a general target value of the HVAC auto unit, wherein the personal target value is a personal target adjustment that indicates a difference between the general target value of the HVAC auto unit and a preferred target value of the user of the vehicle upon the HVAC auto unit.

14. The system of claim 13, wherein the method further comprises:
combining the general target value of the HVAC auto unit and the personal target adjustment to obtain the one or more target values to control the HVAC system of the vehicle.

15. The system of claim 10, wherein the method further comprises:
collecting historical data describing environmental measurements and one or more states of the HVAC system associated with the vehicle or the user of the vehicle; and
generating the personal inference model for the vehicle or the user of the vehicle based on the historical data.

16. The system of claim 10, wherein the one or more inference models are trained by using the data describing environmental measurements and one or more states of the HVAC system collected at a current time, lagged target values inferred at one or more previous times, and a current target value at the current time as training data.

17. The system of claim 16, wherein the current target value at the current time is set by the user or controlled by a HVAC controller of the HVAC system.

18. The system of claim 10, wherein collecting data describing environmental measurements and one or more states of the HVAC system comprises:
collecting additional data comprising one or more of vehicle state data describing one or more states of the vehicle, user identity data describing an identity of the user, user status data describing status of the user, user demographic data describing demographic information associated with the user, and external data describing external information.

19. A vehicle system, comprising:
one or more sensors equipped in or outside of a vehicle;
a HVAC system equipped on the vehicle; and
a computing device comprising:
a processor; and
a non-transitory computer-readable storage medium storing instructions that, when executed by the processor, cause the computing device to perform a method for controlling the HVAC system, the method comprising:
collecting data from the one or more sensors equipped in or outside of the vehicle;
predicting one or more target values by inputting the collected data into one or more inference models that include a personal inference model, wherein the personal inference model is used to predict a personal target value for the vehicle or a user of the vehicle; and
outputting the one or more target values including the personal target value for the vehicle or the user of the vehicle to control the HVAC system.

20. The vehicle system of claim 19, wherein the one or more inference models comprise a general inference model used to obtain a general target value for an average vehicle or an average user of vehicles, and wherein predicting one or more target values further comprises:
predicting the general target value for the average vehicle or the average user of vehicles by inputting the collected data into the general inference model,
wherein the personal target value is a personal target adjustment indicating a difference of preference between the vehicle and the average vehicle or a difference of preference between the user of the vehicle and the average user of vehicles.
